(19) United States
(12) Patent Application Publication
(10) Pub. No.: US 2010/0034916 A1
(43) Pub. Date: Feb. 11, 2010

(54) FORMING METHOD FOR REFINISHING PREFORMED PLATE AND FORMING MOLD MATCHING THEREWITH

(75) Inventor: Chi-Cheng Hsiao, Taipei (TW)

Correspondence Address: STEVENS & SHOWALTER LLP, 7019 CORPORATE WAY, DAYTON, OH, 45459-4238, US

(73) Assignee: INVENTEC CORPORATION, Taipei (TW)

(21) Appl. No.: 12/239,930

(22) Filed: Sep. 29, 2008

(30) Foreign Application Priority Data
Aug. 8, 2008 (TW) 097130417

(51) Int. Cl. B29C 59/02

(52) U.S. Cl. 425/346

(57) ABSTRACT

A forming method for refinishing a preformed plate and a forming mold matching therewith are described. The forming method includes the following steps. First, a distribution condition of a preformed region of a plate is analyzed. Then, a forming mold with forming members selectively disposed is supplied to press the preformed region of the plate, such that the plate is formed into a refinished structure.

### CROSS-REFERENCE TO RELATED APPLICATIONS

This non-provisional application claims priority under 35 U.S.C. § 119(a) on Patent Application Ser. No(s). 097130417 filed in Taiwan, R.O.C. on Aug. 8, 2008 the entire contents of which are hereby incorporated by reference.

### BACKGROUND OF THE INVENTION

1. Field of Invention

The present invention relates to a plate forming method, and more particularly to a forming method for refinishing a preformed plate and a forming mold matching therewith.

2. Related Art

During the processing of a plate, processing structures such as strengthening ribs and reinforcing bars often need to be pressed into the plate, so as to enhance the strength of the plate. However, when an object is installed on the pressing finished plate, an uneven structure that is recessed or bent is generated in a specific direction on the originally even surface due to the influence of the downward pressure of the installed object. The generation of the uneven structure brings trouble to the production personnel in the subsequent assembly of relevant components on the plate. A computer casing is taken as an example, the generation of the recess or bending on the plate results in that a circuit board and other components cannot be secured and installed smoothly on the casing and thus are damaged by the improper press of the casing.

The current solutions to the problem that the uneven structure is generated on the plate generally include enhancing the structural strength of the product, changing the designing and forming capability of a mold, or performing strict control and management on the quality. One common practice is routing a plurality of pressing lines in a preformed region where the uneven structure is easily generated on a base plate of the plate. However, the pressing lines can only reduce the problem of unevenness in the same extension direction on the plate. As far as a point, line, and plane where the uneven structure easily occurs on the plate are concerned, the disposition of the pressing lines can only solve the problem of unevenness in the same line of the plate. Therefore, in order to solve the problem of the entire uneven structural plane at the same time, a considerable number of pressing lines need to be routed in the preformed region on the plate or need to be routed deeper. However, such disposition of the pressing lines involves the damage to the structure of the plate itself in that the disposition of more pressing lines severely affects the structural strength of the plate, and cannot provide an effective solution to the entire preformed region.

Therefore, in the prior art, the method of solving the problem that the uneven structure is easily generated on the plate after the plate is installed with an object is reinforcing the preformed region in a single axial direction on the plate. This method not only requires the repeated disposition of pressing lines on the plate, which results in the complexity of procedures, but also damages the structural strength of the plate, and cannot improve the preformed region in the same plane at the same time. Moreover, when the processing structures such as the strengthening ribs or the reinforcing bars exist on the plate, the conventional method cannot be applied to the plate.

### SUMMARY OF THE INVENTION

In view of the above problems, the present invention is directed to a forming method for refinishing a preformed plate. A distribution condition of a preformed region of a pressing finished plate is analyzed in advance, and a position where the preformed region is generated on the plate is determined. Then, a forming mold is provided to perform a pressing procedure for pressing the preformed region and avoiding processing structures (such as strengthening ribs and reinforcing bars) already disposed on the plate, such that the preformed region of the plate is formed into a refinished structure.

The forming mold used in the forming method of the present invention has a first mold plate and a second mold plate. The first mold plate and the second plate each have a plurality of first and second detachable forming members installed on the first and the second mold plates respectively corresponding to the preformed region of the plate. When the first and the second forming members are pressed, the first and the second forming members are disposed matching each other, such that the plate is processed and formed into a refinished structure.

The present invention has the following efficacy. A forming mold is used to press the preformed region of the plate without causing any irrecoverable structural damage to the plate. The forming mold has a forming member selectively installed at any position of the two mold plates. The barrier of the processing structures such as the strengthening ribs or reinforcing bars already existing on the plate can be avoided easily by adjusting the height and position of the forming member, such that the forming mold can perform a refinishing and pressing process on the preformed region precisely, thereby saving steps and the time to finally form the plate to a large extent.

### BRIEF DESCRIPTION OF THE DRAWINGS

The present invention will become more fully understood from the detailed description given herein below for illustration only, and thus are not limitative of the present invention, and wherein:

FIG. 1 is a schematic flow chart of a forming method according to a first embodiment of the present invention;

FIG. 2 is a schematic view illustrating an analysis of a distribution condition of a preformed region of a plate according to the first embodiment of the present invention;

FIG. 3 is a schematic view illustrating a calculation of the distribution condition of the preformed region of the plate according to the first embodiment of the present invention;

FIG. 4 is a schematic view of a forming mold according to the first embodiment of the present invention;

FIG. 5A is a schematic view of a first mold plate according to the first embodiment of the present invention;

FIG. 5B is a schematic view of a second mold plate according to the first embodiment of the present invention;

FIG. 6A is a schematic view of a fixing portion of a bump according to the first embodiment of the present invention, which is helical;

FIG. 6B is a schematic view of the fixing portion of the bump according to the first embodiment of the present invention, which is cylindrical;

FIG. 6C is a schematic view of a pressing portion of the bump according to the first embodiment of the present invention, which is a circular cylinder;

FIG. 6D is a schematic view of the pressing portion of the bump according to the first embodiment of the present invention, which is a polygonal cylinder;

FIG. 6E is a schematic view of the pressing portion of the bump according to the first embodiment of the present invention, which is a cube;

FIG. 7 is a schematic view of placing the plate between the first and the second mold plates according to the first embodiment of the present invention;

FIG. 8 is a schematic view of pressing the plate by the first and the second mold plates according to the first embodiment of the present invention;

FIG. 9 is a schematic view of the preformed region of the plate according to the first embodiment of the present invention;

FIG. 10 is a schematic view for the preformed region of the plate to be formed into a refinished structure according to the first embodiment of the present invention;

FIG. 11 is a schematic view for the first mold plate to have a pressure plate according to a second embodiment of the present invention;

FIG. 12 is a schematic view of the first and the second mold plates before the pressing according to the second embodiment of the present invention; and

FIG. 13 is a schematic view of the first and the second mold plates after the pressing according to the second embodiment of the present invention.

### DETAILED DESCRIPTION OF THE INVENTION

In the forming method for refinishing a preformed plate in the present invention, the so-called plate is a malleable metal plate having at least one processing structure such as a strengthening rib or a reinforcing bar to enhance its structural strength, for example, a pressing formed element applied in a casing of an electronic device, an iron cabinet, an iron box, and the like which needs to be processed. A metal plate to be used as the casing of a server is taken as an example in the present invention, but the present invention is not limited thereto.

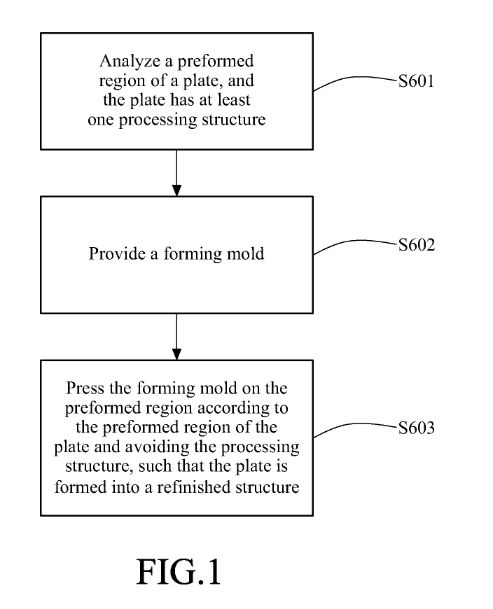

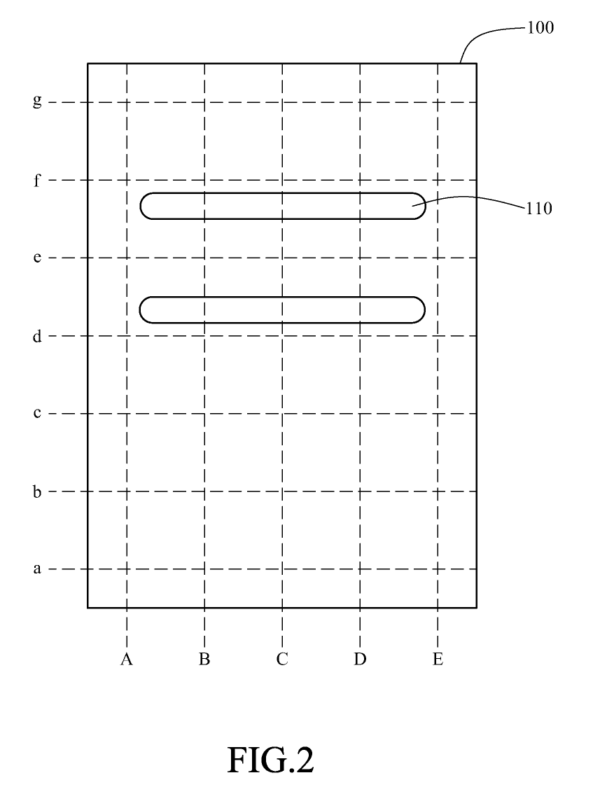

FIG. 1 is a schematic flow chart of a first embodiment according to the present invention. The forming method for refinishing the preformed plate disclosed in the present invention includes first randomly selecting a plurality of plates 100 that have been pressing finished and each having at least one processing structure 110, and analyzing a distribution condition 101 of a preformed region appearing on the plates 100. The processing structure 110 is, but not limited to, a structure that increases the strength such as the strengthening rib and the reinforcing bar. For example, first, the plate 100 is divided into regions of small area, for example, according to a horizontal axis (A-E) and a vertical axis (a-f) thereof (as shown in FIG. 2), and then, a statistical induction and calculation is performed to obtain the distribution condition 101 of the preformed region appearing on the plate (as shown in FIG. 3) (S601).

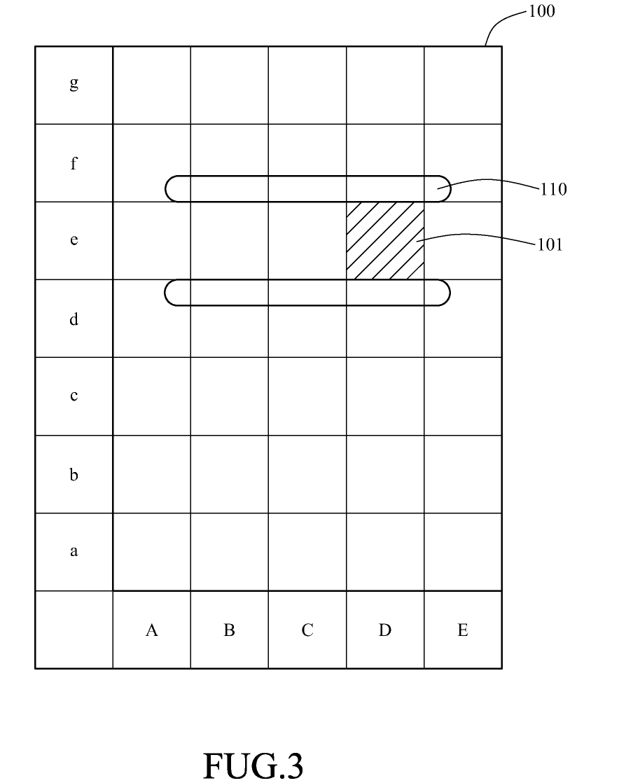

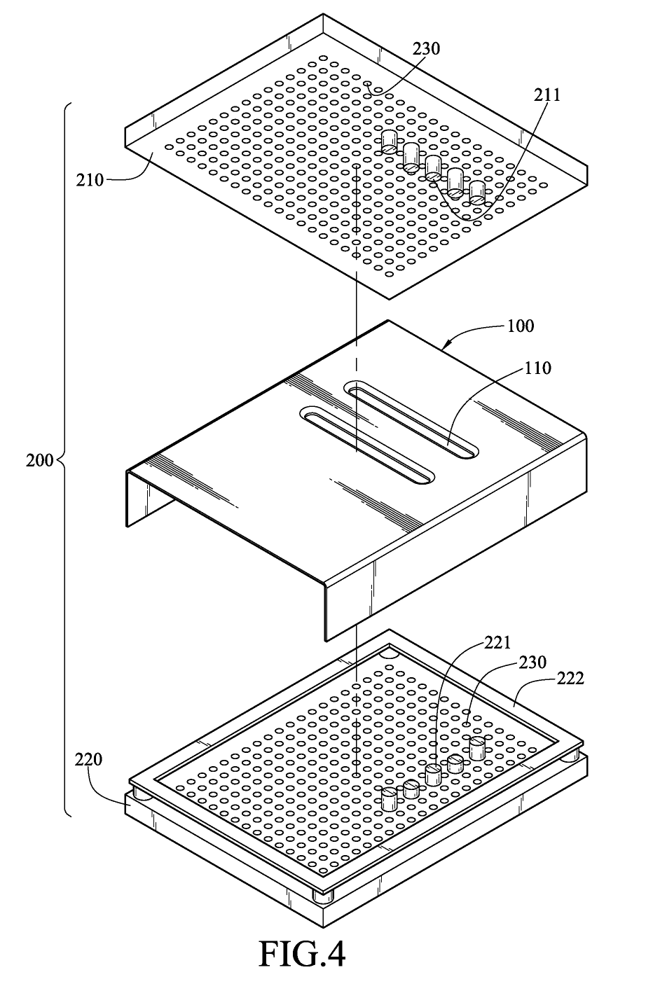

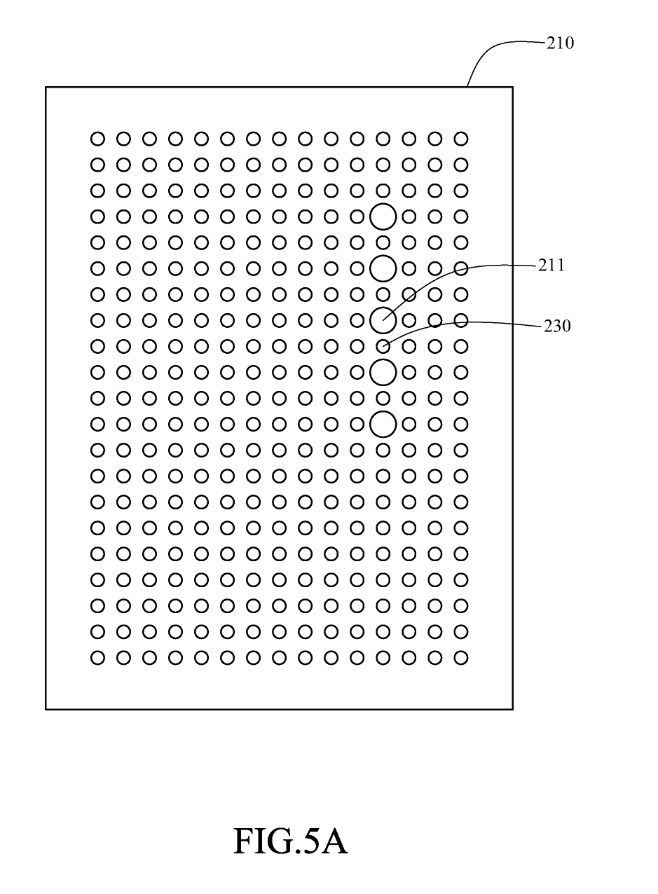

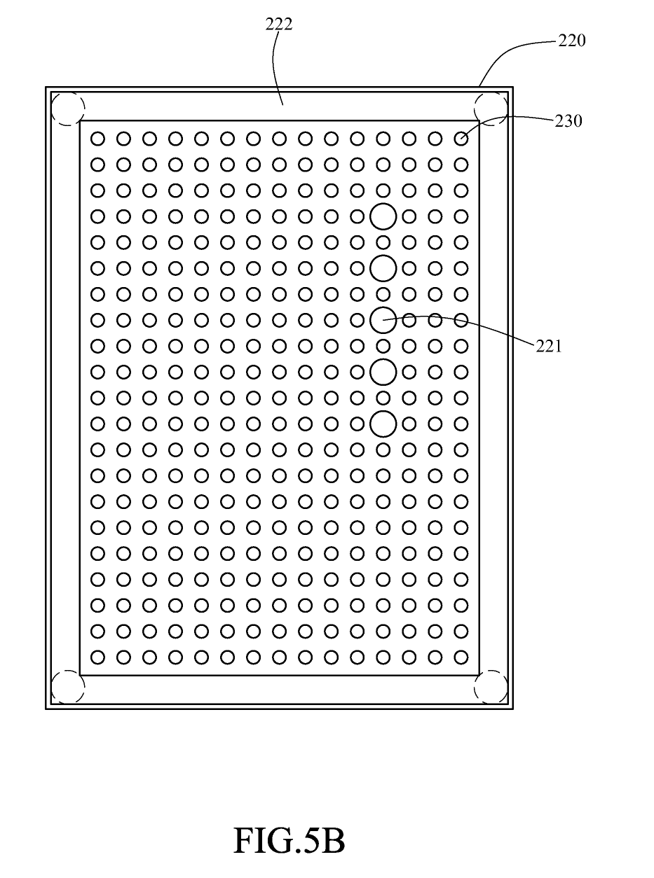

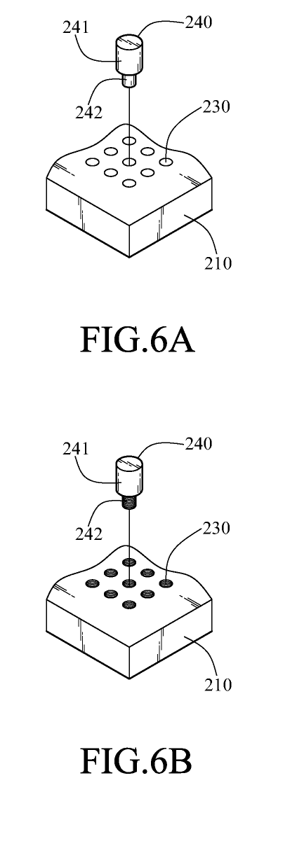

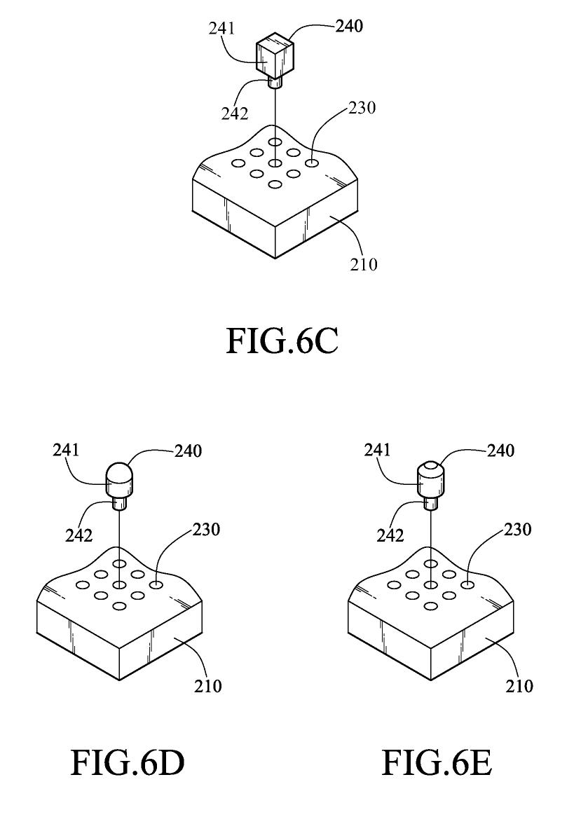

Then, a forming mold 200 is provided according to the analysis result (S602), as shown in FIG. 4. The forming mold 200 of the present invention includes a first mold plate 210 and a second mold plate 220. The first mold plate 210 and the second mold plate 220 respectively have a plurality of holes 230 opened, for detachable first forming members 211 and second forming members 221 with adjustable positions to be disposed therein (as shown in FIGS. 5A and 5B). The first forming members 211 and the second forming members 221 are of a bump structure 240. The bump structure 240 has a pressing portion 241 and a fixing portion 242 (as shown in FIG. 6A). The diameter of the pressing portion 241 is larger than that of the fixing portion 242, and meanwhile the diameter of the fixing portion 242 matches with that of the holes 230 on the first mold plate 210 and the second mold plate 220, such that the fixing portion 242 may be inserted into the hole 230 tightly. Or, the hole 230 is disposed therein with a helical structure matching with the fixing portion 242 for the bump structure 240 to be locked in the hole 230. Therefore, the bump structure 240 may be installed on or detached from the first mold plate 210 or the second mold plate 220 in the insertion or locking manner upon demands in use. The shape of the pressing portion 241 of the bump structure 240 may be, but not limited to, a cylinder shown in FIG. 6A or a circular cylinder, a polygonal cylinder, a cube, or the like (as shown in FIGS. 6B to 6E). In addition, the second mold plate has a fixing frame 222 for the plate 100 to be placed thereon.

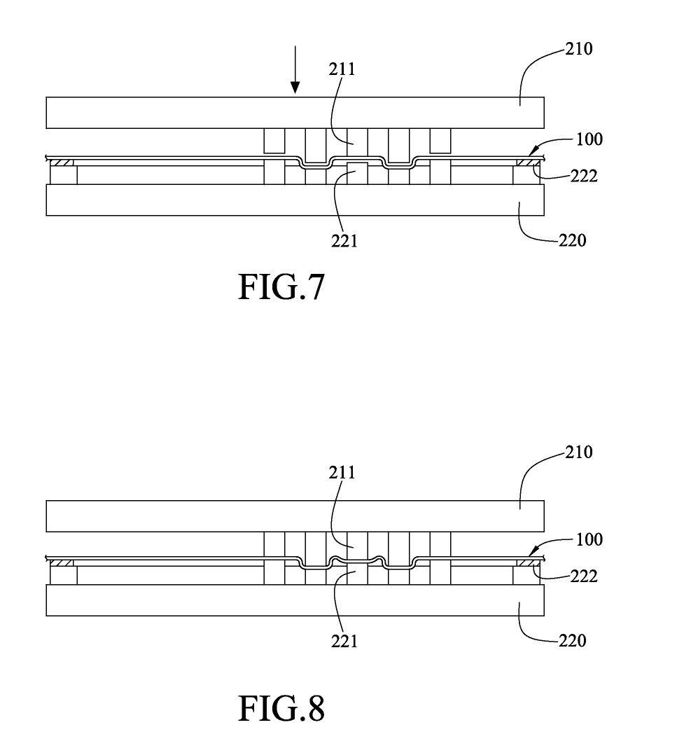

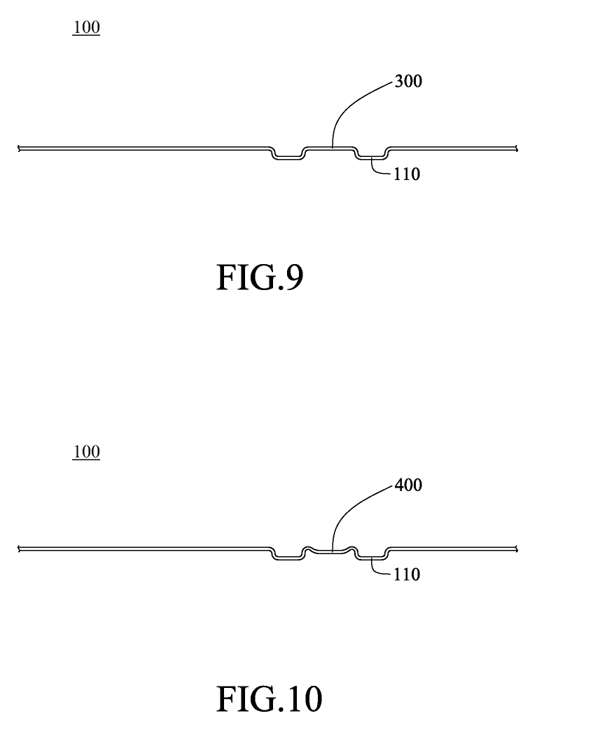

Referring to FIGS. 5A and 5B again, according to the distribution condition 101 of the preformed region of the plate 100, a plurality of first forming members 211 corresponding to the preformed region 300 (as shown in FIG. 9) is disposed on one side of the first mold plate 210, and a plurality of second forming members 221 is disposed on one side of the second mold plate 220 relative to the first mold plate 210, such that the first forming members 211 and the second forming members 221 are correspondingly arranged matching each other. Referring to FIGS. 7 and 8 at the same time, the barrier of the processing structure 110 of the plate 100 may be avoided by selecting the first forming members 211 and the second forming members 221 having the pressing portions 241 of different lengths. Or, the function of avoiding the barrier of the processing structure 110 may be achieved by adjusting locking depths of the fixing portions 242 of the first forming members 211 and the second forming members 221 in the mold plates 210 and 220. The plate 100 is placed on the fixing frame 222 of the second mold plate 220. At this time, the plate 100 is located between the first mold plate 210 and the second mold plate 220. When the first mold plate 210 approaches the plate 100 and exerts a downward pressure, the first forming members 211 first contact the plate 100 and press the plate 100 against the second forming members 221 of the second mold plate 220, such that the preformed region 300 of the plate 100 is formed into a refinished structure 400 under the influence of the pressing stress (as shown in FIG. 10) (S603).

The refinished structure 400 is a slightly deformed structure generated by the preformed region 300 under the pressing stress, and the structure itself has an internal stress which can effectively enhance the structural strength of the preformed region 300 of the plate 100. When the pressing finished plate 100 has an object installed thereon, a downward pressure generated by the installed object is counteracted by an opposite acting force provided by the refinished structure 400, so as to enable the plate 100 to remain a planar state after being installed with the object, thereby effectively solving the problem that an uneven structure that is recessed or bent is easily generated on the plate 100 after the plate is installed with the object.

The first forming members 211 and the second forming members 221 respectively disposed on the first mold plate 210 and the second mold plate 220 can be correspondingly disposed according to the distribution condition 101 of the preformed region of the plate 100. Therefore, the refinishing procedure can be performed according to the region area to be processed on the plate 100 without being limited to the single direction of pressing lines. The lengths and strokes of the forming members 211 and 221 on the forming mold 200 can be adjusted as well, such that the problem of preformed regions 300 of different forms can be solved by this forming method. Moreover, the processing structure 110 already existing on the plate 100 also can be avoided, and thus the forming method is not limited by the structure of the plate 100.

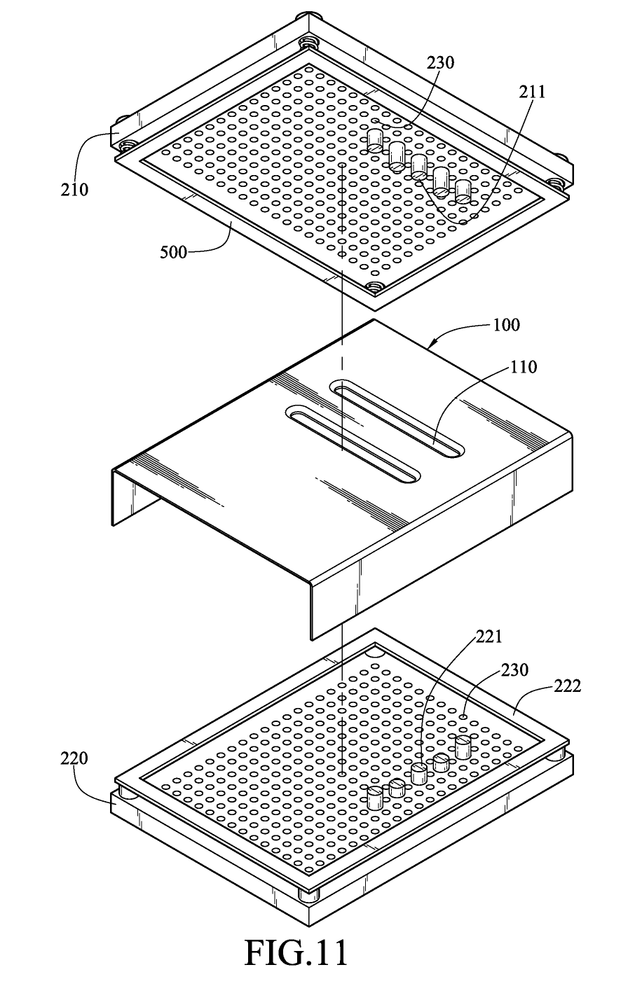

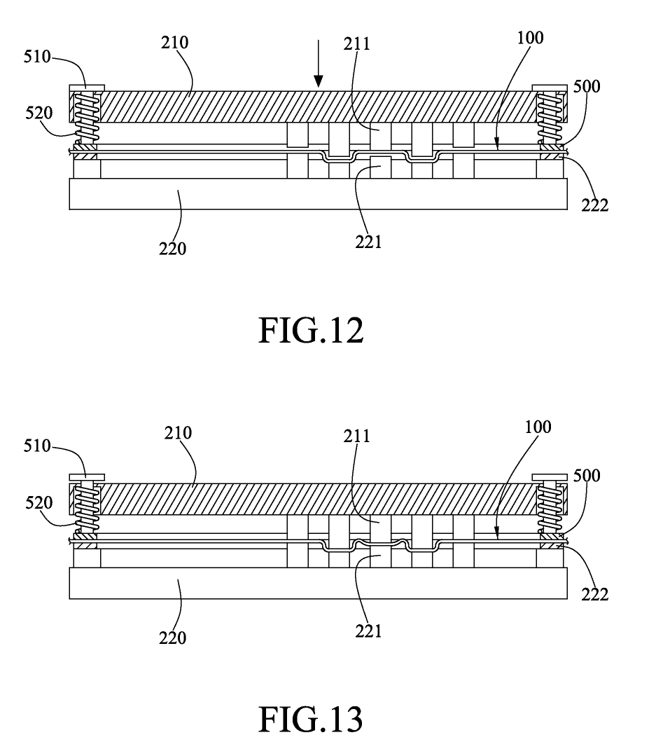

FIGS. 11 to 13 are schematic views of a second embodiment according to the present invention. The first mold plate 210 further has a pressure plate 500 disposed thereon. The pressure plate 500 has four displacement rods 510 and four elastic elements 520 respectively fitted on the displacement rods 510. The elastic elements 520 are springs. The displacement rods 510 are fitted at four corners of the first mold plate 210 at one ends thereof and connected to the pressure plate 500 at the other ends thereof. Both ends of the elastic elements 520 push against the first mold plate 210 and the pressure plate 500 in a normal state, such that the first mold plate 210 and the pressure plate 500 are spaced by a fixed distance from each other under no force. The pressure plate 500 of the present invention is used to fix the plate 100 on the fixing frame 222 of the second mold plate 220 to avoid the displacement of the plate 100 in the performing process, which causes an undesirable effect of the preprocessing. When a downward pressure larger than the elastic force of the elastic elements 520 is exerted on the first mold plate 210, the first forming members 211 are moved towards the second mold plate with the first mold plate 210 and match with the second forming members 221 disposed on the second mold plate 220 (as shown in FIG. 13), so as to achieve the purpose of forming the plate 100 into a refinished structure 400.

It should be noted that, the number and the disposed positions of the displacement rods and the elastic members disclosed in the present invention are not limited to this embodiment, and variations thereof may also be made by those skilled in the art.

The forming method for refinishing the preformed plate in the present invention first analyzes the preformed region of the plate, and thus is also applicable to a large-scale plate having an overall area larger than the first module. The first mold plate may be set as a movable mold plate and operated by a mechanical device (for example, a mechanical arm), such that the first mold plate is moved to a position to be pressed into a refinished structure on the large-scale plate and then performs the pressing.

Therefore, in the present invention, after the plates are pressing formed, positions of preformed regions generated on these pressing formed plates are analyzed in advance. Moreover, a forming mold having forming members with adjustable heights and positions is used to perform the pressing step on the preformed regions of the plates, and the barrier of the processing structures already existing on the plate may be avoided at the same time, such that the preformed regions of the plates are formed into a refinished structure, thereby facilitating the subsequent assembly procedures. In this way, the yield of the product may be increased to a large extent, and the purpose of solving the problem of the preformed regions may be solved without causing an irrecoverable structural damage to the plates.

What is claimed is:

1. A forming method for refinishing a preformed plate, comprising:
analyzing a preformed region of a plate having at least one processing structure;
providing a forming mold; and
pressing the preformed region by the forming mold according to the preformed region of the plate and avoiding the processing structure, such that the preformed region is formed into a refinished structure.

2. A forming mold matching with the method according to claim 1, comprising:
a first mold plate, having a plurality of first forming members on one side thereof, wherein the first forming members is selectively installed on the first mold plate corresponding to the preformed region of the plate and the processing structure; and
a second mold plate, having a fixing frame and a plurality of second forming members on one side thereof relative to the first mold plate, wherein positions of installing the second forming members are matching with the first forming members;
wherein the plate is placed on the fixing frame and is pressed by the first and the second mold plates, such that the plate is formed into a refinished structure by the first and the second forming members.

3. The forming mold according to claim 2, wherein the first mold plate further has a pressure plate for pressing the plate on the fixing frame.

4. The forming mold according to claim 3, wherein the pressure plate further has at least one displacement rod and at least one elastic element, the displacement rod is fitted on the first mold plate at one end thereof and connected to the pressure plate at the other end thereof, and the elastic element is fitted on the displacement rod, such that a distance exists between the pressure plate and the first mold plate.
